(19) United States
(12) Patent Application Publication
(10) Pub. No.: US 2023/0226609 A9
(43) Pub. Date: Jul. 20, 2023

(54) THREE-DIMENSIONAL PRINTING METHOD

(71) Applicant: Nanjing Taitao Intelligent System Co., Ltd., Nanjing (CN)

(72) Inventor: Fupeng Liang, Nanjing (CN)

(73) Assignee: Nanjing Taitao Intelligent System Co., Ltd., Nanjing (CN)

(21) Appl. No.: 17/050,357

(22) PCT Filed: Oct. 15, 2018
(86) PCT No.: PCT/CN2018/110211

§ 371 Date: Jan. 13, 2021

(30) Foreign Application Priority Data
Apr. 24, 2018 (CN) 201810375235.7

(51) Int. Cl. B22F 10/20; B33Y 10/00; B22F 10/30

(52) U.S. Cl. CPC B22F 10/20; B33Y 10/00; B22F 10/30; H05B 3/0004

(57) ABSTRACT

Disclosed is a three-dimensional printing method for instantly generating a needed molten raw material by way of a resistance heating function during three-dimensional printing. The method can realize three-dimensional printing of material having a high melting point and falls within the technical field of additive manufacturing. The method is characterized by applying a current through a solid raw material and a body to be printed; partially or fully heating the solid raw material located between a guiding device and said body to be printed into a molten state by way of resistance heating; and generating a molten raw material in a space located between the guiding device and the body to be printed. During the accumulation of the molten raw material, an area of the body to be printed and where the molten raw material is to be accumulated and/or is being accumulated is heated; or, the body to be printed is heated; or, the area of the body to be printed and where the molten raw material is to be accumulated and/or is being accumulated is heated, and the body to be printed is heated.

### TECHNICAL FIELD

The present invention relates to forming technology in three-dimensional printing technology, and especially to a three-dimensional printing method that instantly generates the required molten raw material through resistance heating during the three-dimensional printing process, which can realize three-dimensional printing of high melting point materials. The invention falls within the technical field of additive manufacturing.

### BACKGROUND

Three-dimensional printing technology was originated in the United States at the end of the 19th century, and gradually commercialized in Japan and the United States until the 1970s and 1980s. The common mainstream three-dimensional printing technologies, such as Stereo Lithography Apparatus (SLA), Fused Deposition Modeling (FDM), Selecting Laser Sintering (SLS), and Three Dimensional Printing and Gluing (3DP), were commercialized in the United States in the 1980s and 1990s. In the technology of three-dimensional printing by stacking melting raw materials, such as common FDM plastic printing and other metal printing with similar principles, one of the important core components is the furnace/extrusion head/generator for producing the molten raw material. Another example, the printing technology of jetting melting raw materials also belongs to stacking of melting raw material, and its melting raw material jetting device also is the core component. At present, there are many patent applications for generating devices for producing molten metal raw materials, such as the Chinese patent application No. 201410513433.7 entitled “3D Printing Head for Metal Melt Extrusion Shaping”; or Chinese patent application No. 201520533246.5 entitled “Device for Extrusion Deposition Forming of Semi-solid Metal”. In these patent applications, it is impossible to produce droplets, but possible to produce a continuous flow of metal. There is also a way to use air pressure as the jet power to produce metal droplets, for example, the device and method described in the document “Experiments on remelting and solidification of molten metal droplets deposited in vertical columns” (source: Journal of Manufacturing Science and Engineering-Transactions of the Asme, 2007, Vol. 129, Issue 2, pages 311-318), wherein the main principle is to use pulsed airflow to generate pulsed pressure vibration in the micro furnace/crucible to form metal droplets at the nozzle outlet; another example, the method used in the Chinese patent application No. 201520561484.7 entitled “Liquid Metal Print Cartridge” is similar to the technology described in this document; another example, the Chinese patent application No. 201520644682.X entitled “Device for Metal 3D Printing and Supporting Structure”, which also employs pulsed airflow/air pressure to achieve metal droplet generation. These methods of producing metal droplets all are to generate the metal droplets by applying pulse pressure and using the characteristics of the fluid, and can also produce a continuous flow of liquid metal. However, these technologies cannot continuously add solid raw materials during the work process, which will bring inconvenience to some printing situations (such as printing large metal parts), and further due to the fact that the gas is a compressible material form, there is a delay in pressure conduction, the formation speed of metal droplets is not high, and the more serious is the poor controllability. In the prior art, if the ratio of the inner diameter of the nozzle to the inner diameter of the liquid raw material storage bin or main runner is too small (for example, the inner diameter of the liquid raw material storage bin or main runner connected to the nozzle is 2 mm, and the inner diameter of the nozzle is 50 microns), especially when the raw material is liquid metal, the surface tension and viscosity of liquid raw materials are relatively high, and large pressure must be applied to overcome the surface tension and flow resistance to achieve spraying.

The jetting technology commonly used in 2D printing technology can quickly produce droplets, such as, the jetting technology of inkjet printers developed by companies such as HP of the United States and Epson of Japan, wherein liquid injection is realized based on deformation extrusion of the runner (electrodeformable material is provided on the nozzle runner wall), or local heating and evaporation (a heating element is provided on the nozzle runner wall). However, these technologies are not suitable for injection of the melts of the materials with high melting points (such as aviation aluminum alloy, copper, stainless steel, etc.), and are not suitable for the injection of high-viscosity liquid materials. In terms of the Multi-Jet-Fusion (MJF) plastic 3D printing technology disclosed by Hewlett-Packard Company of the United States in 2015, although the jetting technology of 2D inkjet printing is used, the jetted liquid is only some auxiliary reagents with high fluidity (the sprayed reagent is in a liquid state at room temperature), and the main material still is solid plastic powder (using a method similar to SLS powder coating technology to achieve plastic powder coating).

There are also liquid raw material injection methods based on electric field force, for example, “Electric Field Injection” Technology (see the book “Electric Field Injection”, author Li Jianlin, Shanghai Jiaotong University Press, 2012); another example, the application No. 201610224283.7 entitled “Liquid Metal Printing Equipment”; the application No. 201310618953.X entitled “Variable Diameter 3D Printer Driven by High-voltage Electrostatic”, etc., wherein these Chinese patent applications also use the electric field driving technology. The said technologies are to establish a high-voltage electrostatic field or a pulsed high-voltage electrostatic field between the nozzle (the nozzle must be made of a non-conductive material) and the external electrode (printing support platform as the electrode) to achieve the ejection of liquid raw materials. However, “electric field jetting” also has its limitations. For example, due to the viscosity of liquid raw materials, especially liquid metals with great surface tension, high-voltage electrostatic fields or even ultra-high-voltage electrostatic fields must be applied, so as to generate the pulling force required to overcome the viscous force and surface tension of the liquid raw material and generate a certain flow speed; the high-voltage electric fields are dangerous, prone to electrical breakdown, and its controllability is not high; and due to the low controllability of the high-voltage electric field, the controllability of the electric field jetting process is not high, and so the controllability of the generated droplets is not high.

As mentioned above, the many existing technologies for producing the molten raw materials cannot produce a molten raw material of high melting point metals, such as tungsten, molybdenum, and also cannot produce a molten raw material of high-temperature resistant cermets, such as titanium carbide. In addition, the prior art has high energy consumption in the process of producing the molten raw materials.

The technologies that have been commercialized for three-dimensional printing of metal materials at present mainly include Selective Laser Melting (SLM), Laser Coaxial Powder Feeding/Laser Engineered Net Shaping Technology (LENS), and Electron Beam Melting (EBM). But, these technologies also have many disadvantages, for example, SLM and EBM have high manufacturing costs, high maintenance costs, low mechanical strength of the printed parts (required to be enhanced after printing), and small printed format. In order to enhance the material density of the metal parts printed by SLM and EBM technology, many technologies have emerged, such as the Chinese patent application No. 201410289871.X, titled “Processing Method for Improving Performances of 3D Printed Metal Parts”. In view of the shortcomings of the above-mentioned SLM and EBM technologies, many low-cost metal 3D printing technologies using other forming methods also have appeared, such as, the Chinese patent application No. 201510789205.7 entitled “Method and Device for Direct 3D Printing Manufacturing using Liquid Metal”; the Chinese patent application No. 201510679764.2 entitled “Metal 3D Printing and Fast Prototyping Device”; or the Chinese patent application No. 201410206527.X entitled “Extrusion Metal Flow 3D Printer”. However, these technologies have problems such as low forming accuracy or low interlayer bonding force of the printed metal layers, and they cannot print high melting point materials (such as tungsten alloy materials).

Contents of the Invention

One object of the present invention is to provide a three-dimensional printing method capable of printing high melting point materials (especially metals).

Another object of the present invention is to provide a method for generating molten raw materials for high-temperature resistant conductive materials, to realize three-dimensional printing of high-temperature resistant parts.

In order to achieve the above objects, the present invention adopts the following technical solutions.

A three-dimensional printing method, which mainly comprises the steps of placing a molten raw material in a forming area used by a three-dimensional printing apparatus, when cooled down, the molten raw material being converted into a printed workpiece, the molten raw material being accumulated on the basis of the printed workpiece until an object to be printed is formed, and the accumulated printed workpiece constituting the object to be printed, wherein: in the process of accumulating the molten raw materials, the position in which the molten raw material is placed is determined by the shape and structure of the object to be printed; the forming area used by the three-dimensional printing apparatus refers to a space used by the three-dimensional printing apparatus when printing the object; and during the three-dimensional printing process the molten raw material is obtained by heating a solid raw material, a guiding device is used to guide the movement of the solid raw material, and the molten raw material is a raw material in a molten or semi-molten state,

characterized in that,

applying a current through the solid raw material and the printed workpiece, partially or completely heating the solid raw material located between the guiding device and the printed workpiece into a molten state by way of resistance heating, and generating the molten raw material in a space located between the guiding device and the printed workpiece,

wherein, in the process of accumulating the molten raw materials:

heating the area of the printed workpiece where the molten raw material is about to be accumulated and/or is being accumulated (for example, heating to a molten or semi-molten state), which is independent of the resistance heating generated by applying current through the solid raw material and the printed workpiece;

alternatively, heating the printed workpiece, which is independent of the resistance heating generated by applying current through the solid raw material and the printed workpiece;

alternatively, heating the area of the printed workpiece where the molten raw material is about to be accumulated and/or is being accumulated and heating the printed workpiece, which is independent of the resistance heating generated by applying current through the solid raw material and the printed workpiece.

The heating (preheating) of the area of the printed workpiece where the molten raw material is about to be accumulated and/or is being accumulated, or the heating (preheating) of the printed workpiece can obtain the following technical benefits: during the process of applying resistance heating current through the solid raw material and the printed workpiece, the temperature of the part of the printed workpiece contacting with the solid raw material or molten raw material is increased in advance; thereby, the resistance value (resistivity) of the part of the printed workpiece contacting with the solid raw material or molten raw material is increased, so as to obtain a higher voltage partial pressure and help to increase the temperature of the contacting part (for example, the contacting part is melted), and thereby the connection strength between the newly-accumulated molten raw material and the previously-formed printed workpiece is improved.

Alternatively,

in terms of the heating (preheating) of the area of the printed workpiece where the molten raw material is about to be accumulated and/or is being accumulated, or the heating (preheating) of the printed workpiece, the heating intensity is controllable and the heating source can be turned off and on; the heating source refers to a functional module or device that produces heating.

Alternatively,

the current is applied through solid raw material and printed workpiece, part or all of the solid raw material in contact with the printed workpiece is heated to a molten state or a semi-molten state through resistance heating, a molten raw material is produced in the space between the solid raw material and the printed workpiece;

and/or, the current is applied through solid raw material and printed workpiece, part or all of the solid raw material adjacent to the printed workpiece is heated to a molten state or a semi-molten state through resistance heating, a molten raw material is produced in the space between the solid raw material and the printed workpiece; the solid raw material adjacent to the printed workpiece refers to the solid raw material adjoining to the previously-produced molten raw material.

Alternatively,

the printed workpiece is supported by a support platform, the support platform is an apparatus or structure for supporting the printed workpiece during the three-dimensional printing process.

Alternatively,

in terms of the heating of the area of the printed workpiece where the molten raw material is about to be accumulated and/or is being accumulated, the heating apparatus is controlled, and the heating area (such as position) is controlled.

Alternatively,

the position of the molten raw material is controlled by the processes of: the molten raw material is pushed toward the printed workpiece or the support platform and is far away from the guiding device by the moving caused by the solid raw material's outputting from the guiding device, and the accumulating position of the molten raw material is controlled by the relative moving between the solid raw material and the printed workpiece.

The above process of controlling the position of the molten raw material can be understood as: the molten raw material is generated instantly in the space between the guiding device and the printed workpiece or support platform, the position of the solid raw material that is about to be heated to generate the molten raw material affects the position of the molten raw material; the molten raw material is adhered with the solid raw material, and the molten raw material is sticky, and the movement of the solid raw material also will drive movement of the molten raw material adhered to it.

The above process of controlling the position of the molten raw material also can be understood as: the solid raw material and/or printed workpiece is driven by a position-drive mechanism, the molten raw material between the solid raw material and the printed workpiece that has not been in contact with the printed workpiece moves with the solid raw material; the molten raw material in contact with the printed workpiece is attached to the printed workpiece or moves with the printed workpiece.

Alternatively,

the three-dimensional printing process is carried out in a vacuum environment, and the vacuum is used to reduce the external heat conduction of the printed workpiece.

Alternatively,

the heating of the area of the printed workpiece where the molten raw material is about to be accumulated and/or is being accumulated is caused by a method which comprises one or a combination of at least two of plasma heating, electrical arc heating, electromagnetic induction heating, resistance heating, laser heating, electron beam heating, and microwave heating.

Alternatively,

the form of the solid raw material is linear, rod-shaped, or granular.

Alternatively,

the solid raw material is a conductive material.

Alternatively,

the heating of the printed workpiece is caused by a method which comprises one or a combination of at least two of resistance heating, electromagnetic induction heating, and microwave heating. The printed workpiece can be heated as a whole, for example, the support platform is used as a heating plate, the heat of the support platform is transferred to the printed workpiece, and the printed workpiece is heated as a whole.

Alternatively,

the main steps of the three-dimensional printing method include:

Step S1: heating the part of the printed workpiece where the molten raw material is about to be accumulated;

Step S2: outputting the solid raw material from the guiding device;

Step S3: establishing an electrical connection between the solid raw material and the printed workpiece, that is, the current can flow between the solid raw material and the printed workpiece, which is a resistance connection, not a connection through an electrical arc;

Step S4: applying current through the solid raw material and the printed workpiece, partially or completely heating the solid raw material between the guiding device and the printed workpiece into a molten state by way of resistance heating;

Step S5: controlling a scanning position of the solid raw material on the printed workpiece by regulating the relative position between the guiding device and the printed workpiece, at the same time outputting the solid raw material from the guiding device; during this process, heating the part of the printed workpiece where the molten raw material is about to be accumulated and/or heating the part of the printed workpiece the molten raw material is being accumulated, applying current through the solid raw material and the printed workpiece and performing resistance heating on the solid raw material to continuously produce the molten raw material;

the applying of current through the solid raw material and the printed workpiece is to apply current through the guiding device contacting with the solid raw material and the printed workpiece, or to apply current through an electrode contacting with the solid raw material and the printed workpiece.

Alternatively,

when there is no need to continue producing the molten raw material, or when the three-dimensional printing is suspended or stopped, the current is applied through the solid raw material and the printed workpiece, with the current intensity that is sufficient to fuse and break the molten raw material between the guiding device and the printed workpiece, or sufficient to fuse and break the molten raw material between the electrode contacting with the solid raw material and the printed workpiece.

The present invention has the following beneficial effects.

(1) The present invention does not use vessels such as furnaces or crucibles or extrusion heads. In the present invention, by directly applying current to the solid raw material and resistance heating (i.e., resistance radiation), the specific part of the solid raw material is heated into a molten state, so that the range of heating energy is concentrated, the volume of the molten raw material is small, and the generation speed of the molten raw material is fast, which belongs to “on-demand real-time generation”; and the position status of the molten raw material is controlled by controlling the position status of the solid raw material, rather than controlling the position status of the molten raw material by way of compressible media such as gas; and the output of the molten raw material is not controlled by a furnace, crucible or extrusion head. Because the molten raw material is small in size and directly adhered to the solid raw material, the response speed to the position control of the molten raw material is high, and therefore the invention has the advantages of high controllability, low energy consumption, simple structure and low cost.

(2) The present invention does not use vessels such as furnaces or crucibles or extrusion heads, and is not limited by the vessel performances (such as melting point), and it is possible to produce molten raw materials of the high-melting point conductive materials such as tungsten (having the melting point of about 3400° C.), and the molten raw material of high-temperature cermets. The invention can be applied to printing the high-melting point tungsten alloy parts and high-temperature cermet parts, which is of great significance.

(3) In the present invention when there is no need to continue producing the molten raw material, that is, when the output of molten raw material is stopped, the subsequent raw materials are cut off from the printed workpiece or support platform by way of fusing. The invention eliminates the common problems in three-dimensional printing technology of molten raw material generation technology about the “container” type (i.e., furnace or crucible or extrusion head), such as the problems that “molten raw material remains or accumulates at the nozzle of the container”, and “printing material remains or adheres between the container nozzle and the printed workpiece”.

(4) The invention does not use gas to drive the jetting of molten raw material, and can be used in a vacuum printing environment, and can achieve higher-quality three-dimensional printing and produce high-quality printed parts (higher part density).

(5) In the present invention, by directly applying current to the solid raw material and resistance heating (i.e., resistance warming), the specific part of the solid raw material is heated to a molten state. In this way, the range of heating energy is concentrated and limited, and unlike other three-dimensional printing technologies that use electrical arc, plasma heating and other heating methods to produce molten raw materials, it will not destroy (remelt) the previously-printed structure.

(6) If the present invention employs linear solid raw materials with small wire diameter (such as a wire diameter of 30 microns), the diameter of the pixel (voxel) and the particle diameter on the surface of the printed workpiece are close to the diameter of the linear solid raw material, so that it is possible to achieve higher precision three-dimensional printing than the existing SLM (Selective Laser Melting) and EBM (Electron Beam Melting) technologies.

(7) In the present invention, by directly applying current to the solid raw material and resistance heating (i.e., resistance warming), the specific part of the solid raw material is heated to a molten state. In this way, the choice of printing materials is wide, and there are no such problems in the existing SLM and EBM technologies that the printing material reflects the heating energy and the energy absorption rate is low (this results in that many commonly used materials cannot be three-dimensional printed by SLM and EBM technologies, for example, in metal three-dimensional printing technology, only a few metal materials are currently suitable for SLM and EBM three-dimensional printing).

(8) In the present invention, in the process of accumulating the molten raw materials, by heating (preheating) the area of the printed workpiece where the molten raw material is about to be accumulated and/or is being accumulated, or by heating (preheating) the printed workpiece, the technical advantages can be obtained: the temperature of the part of the printed workpiece contacting with the solid raw material or molten raw material is increased in advance during applying resistance heating current through the solid raw material and the printed workpiece, so as to increase the resistance value (resistivity) of the part of the printed workpiece contacting with the solid raw material or molten raw material. Further, a higher voltage partial pressure can be obtained and the temperature of the contacting part can be increased (for example, the contacting part is melted), so that the connection strength between the newly-accumulated molten raw material and the previously-shaped printed workpiece is improved.

(9) The present invention can control the melting state of the metal at the shaping part in the metal three-dimensional printing and shaping process through the “resistance warming” generated by applying the current. The electric field affects the crystal nucleus growth process of the alloy in the liquid state, and appropriate electric field parameters (such as oscillation frequency, current intensity, etc.) can improve the mechanical properties of the alloy. There are many studies on the influence of the electric field on metal structure, such as the document entitled “Progress in Metal Structure under Pulsed Electric Field” (review), the author: He Lijia, publication: “Journal of Liaoning Institute of Technology”, 2003, Vol. 23, No. 5; or the document entitled “Influence of Applied Electric Field on Alloy Solidification Structure” (review), Author: Liu Jin (etc.), publication: “Casting”, 2012, Vol. 61, No. 8. The present invention can integrate the “metallurgical electric field control” in the shaping process of metal three-dimensional printing.

In summary, the beneficial effects of the present invention are as follows: high controllability, low energy consumption, simple structure, low cost; it is possible to produce molten raw materials of the high melting point conductive materials; no raw material remains after the output of the molten raw material is terminated; it can be used in a vacuum printing environment; the range of heating energy is concentrated and limited, without destroying the fine structure that has been printed; it is possible to achieve the high-precision three-dimensional printing; the selectable range of the printing materials is wide; the resulting part structure is of high strength; and it is possible to integrate the “metallurgical electric field control” into the shaping process of metal three-dimensional printing. Thus, the present invention has substantial progress.

### DESCRIPTION OF THE DRAWINGS

FIGS. 1 and 2 are schematic diagrams for describing the principle of a first specific embodiment of a three-dimensional printing method of the present invention, arrows D1 and D2 in FIG. 2 indicating the moving direction; and

FIG. 3 is a schematic diagram for describing the principle of a second specific embodiment of a three-dimensional printing method of the present invention, arrows D3, D4, and D5 in FIG. 3 indicating the moving direction.

### EMBODIMENTS

Hereinafter, preferred specific embodiments of the present invention are listed and described in detail with reference to the accompanying drawings.

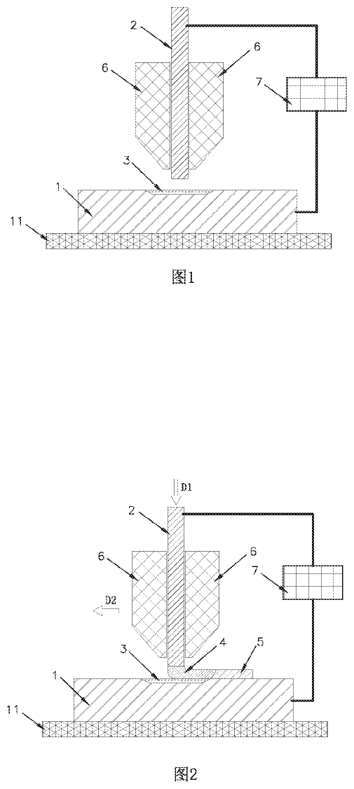

FIGS. 1 and 2 illustrate a first specific embodiment of a three-dimensional printing method of the present invention: a three-dimensional printing method, which mainly comprises the steps of placing a molten raw material in a forming area used by a three-dimensional printing apparatus, the molten raw material being converted into a printed workpiece (that is, printed workpiece I 1) when cooled down, the molten raw material being accumulated on the printed workpiece until an object to be printed is formed, and the accumulated printed workpiece constituting the object to be printed; wherein, in the process of accumulating the molten raw material, the position where the molten raw material is placed is determined by the shape and structure of the object to be printed (in other words, the three-dimensional printing apparatus controls the accumulation position of the molten raw material according to the computer model data corresponding to the object to be printed); the forming area used by the three-dimensional printing apparatus refers to a space used by the three-dimensional printing apparatus when printing the object; and during the three-dimensional printing process the molten raw material is obtained by heating a solid raw material, a guiding device is used to guide the movement of the solid raw material (i.e., solid raw material I 2), and the molten raw material is a raw material in a molten or semi-molten state,

the key is:

applying a current through the solid raw material and the printed workpiece (a heating current is generated through a circuit I 7), partially or completely heating the solid raw material located between the guiding device (i.e., guiding device I 6) and the printed workpiece (i.e., printed workpiece I 1) into a molten state by way of resistance heating, generating a molten raw material (i.e., melting raw material 4) in a space located between the guiding device and the printed workpiece; in this specific embodiment, the intensity of the applied current is an empirical value obtained through multiple tests;

wherein, in the process of accumulating the molten raw material:

heating the area of the printed workpiece where the molten raw material is about to be accumulated and where the molten raw material is being accumulated to produce a high temperature area 3 on the surface of the printed workpiece; the heating being independent of the above resistance heating generated by applying current through the solid raw material and the printed workpiece. The heating of the area of the printed workpiece where the molten raw material is about to be accumulated and where the molten raw material is being accumulated is electromagnetic induction heating in terms of the heating method: focusing the high-frequency alternating magnetic field onto the area where the molten raw material is about to be accumulated and where the molten raw material is being accumulated, and using the “skin effect” produced by the high-frequency alternating magnetic field in this area to produce a high-temperature layer (or even a molten layer) on the surface of this area.

The form of the used solid raw material is linear, and the solid raw material is a conductive material, i.e., a metal wire.

During the three-dimensional printing process, the printed workpiece is supported by a support platform (i.e., support platform I 11); the support platform is an apparatus used to support the printed workpiece during the three-dimensional printing process.

The position control processes of the molten raw material are as follows: movement caused by output of the solid raw material from the guiding device pushes the molten raw material away from the guiding device and toward the printed workpiece (in the direction shown by arrow D1); and the relative movement between the solid raw material and the printed workpiece (in the direction shown by arrow D2) controls the accumulating position of the molten raw material. The solid raw material moves with the guiding device (in the direction shown by arrow D2). When the moving speed of the solid raw material I 2 (in the direction shown by arrows D1 and D2, with the support platform I 11 as the reference) is fast enough (such as the speed is 300 mm/s), and at the same time the resistance heating is maintained to continuously produce the molten raw material, a molten raw material flow can be formed: as soon as the solid raw material I 2 enters the space between guiding device I 6 and printed workpiece I 1, it is heated and melted, and the produced molten raw material is immediately pushed to the printed workpiece I 1 and then accumulated; and since the solid raw material I 2 is constantly replenished and the guiding device I 6 is equipped with a heat dissipation structure (such as a water cooling channel), and the printed workpiece I 1 cannot react quickly enough due to its thermal conductivity to reduce the temperature of the melting raw material 4 to below the melting point, the continuous production and positional change of the melting raw material 4 is visually expressed as a molten raw material flow, however the boundary between solid raw material I 2 and the melting raw material 4 is still solid. This is also the main reason why the conductive materials with high melting point (such as tungsten metal) can be used in the present invention.

In the process of generating and accumulating the molten raw materials, the heating current applied through the printed workpiece I 1 and the solid raw material I 2 can heat and melt the parts of the high temperature area 3 on the printed workpiece surface that are in contact with the molten raw material (the temperature of the high temperature area 3 on the printed workpiece surface is controllable, and its temperature value and the applied current intensity may be empirical values obtained by many tests), and metallurgical welding may be realized between the raw material 5 accumulated on the printed workpiece and the printed workpiece I 1, i.e., realizing the high-strength connection. By controlling the intensity of the above-mentioned heating of the area of the printed workpiece where the molten raw material is about to be accumulated and where the molten raw material is being accumulated and the applied current intensity therefor, it is possible to control whether the connection between the raw material 5 accumulated on the printed workpiece and the printed workpiece I 1 is welding so as to control the connection strength; and in such areas where detachable supports need to be produced, high-strength connections are not required. The detachable support plays a role of supporting the printed parts in the three-dimensional printing technology, just like the scaffolding used in construction (the scaffolding is removed after it is built).

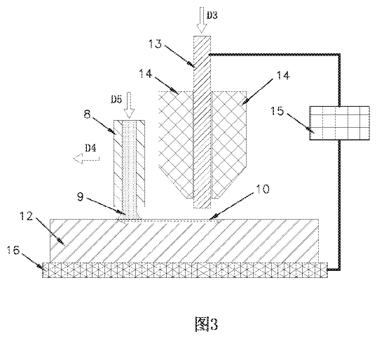

FIG. 3 illustrates a second specific embodiment of a three-dimensional printing method of the present invention.

The second specific embodiment comprises: using a plasma 9 to heat an area of the printed workpiece (that is, printed workpiece II 12) where the molten raw material is about to be accumulated, to form an area 10 heated by the plasma on the surface of the printed workpiece; and using a plasma nozzle 8 to guide jetting of the plasma 9 (in the direction shown by arrow D5) and control the jetting area. The printed workpiece II 12 is supported by a support platform II 16, and the support platform II 16 also is a heating platform (with a resistance heating component inside), which heats the entire printed workpiece II 12. The plasma nozzle 8 and the guiding device II 14 move synchronously (in the direction shown by arrow D4), and the solid raw material II 13 moves under the drive of the guiding device II 14 (in the direction shown by arrow D4). The solid raw material II 13 can be moved to the printed workpiece II 12 under the guidance of the guiding device II 14 (in the direction shown by arrow D3). The plasma nozzle 8 is connected to a position-drive mechanism (not shown in the figure); under the control of the position-driven structure the plasma nozzle 8 is always aimed at the area of the printed workpiece (i.e., printed workpiece II 12) where the molten raw material is about to be accumulated; and since the plasma nozzle 8 and the guiding device II 14 together move rapidly (for example, at a speed of 300 mm/s), when the area previously heated by the plasma 9 comes into contact with the molten raw material or solid raw material, this area still has the higher temperature than other areas not heated by the plasma 9 (the temperature of this area is mainly affected by the overall temperature of the printed workpiece II 12, the thermal conductivity of the material of the printed workpiece II 12, the distance between the said area and the plasma nozzle 8 in the direction indicated by arrow D4, the moving speed of the plasma nozzle 8, the temperature of the plasma 9, the heat capacity of the plasma 9 and other parameters, and the empirical values of these parameters can be obtained through multiple tests). The support platform II 16 has conductivity, and current applied through the solid raw material II 13 and the printed workpiece II 12 is generated by a circuit II 15. Heating the printed workpiece II 12 as a whole can reduce the energy required for heating the area where the molten raw material is about to be accumulated and where the molten raw material is being accumulated, thereby reducing system complexity and improving reliability.

The above embodiments are only preferred specific examples of the present invention, and are not intended to limit the scope of the present invention. The equivalent transformations and modifications made according to the contents of the claims and the description of the present invention still fall within the scope of the present invention.

### LIST OF REFERENCE SIGNS

1—printed workpiece I
2—solid raw material I
3—high temperature area on the printed workpiece surface
4—melting raw material
5—raw material accumulated on the printed workpiece
6—guiding device I
7—circuit I
8—plasma nozzle
9—plasma
10—area heated by the plasma on the surface of the printed workpiece
11—support platform I
12—printed workpiece II
13—solid raw material II
14—guiding device II
15—circuit II
16—support platform II

### SUMMARY

The foregoing and other objects, features, and advantages of the invention will become more apparent from the following detailed description, which proceeds with reference to the accompanying figures.

### BRIEF DESCRIPTION OF THE DRAWINGS

### Detailed Description

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. A three-dimensional printing method, which comprises main processes of placing a molten raw material in a forming area used by a three-dimensional printing apparatus, when cooled down, the previously molten raw material being converted into a printed workpiece, the molten raw material being accumulated on the basis of the printed workpiece until an object to be printed is formed, and the accumulated printed workpiece constituting the object to be printed, wherein: in the process of accumulating the molten raw materials, the position in which the molten raw material is placed is determined by the shape and structure of the object to be printed; the forming area used by the three-dimensional printing apparatus refers to a space used by the three-dimensional printing apparatus when printing the object; and during the three-dimensional printing process the molten raw material is obtained by heating a solid raw material, a guiding device is used to guide the movement of the solid raw material, and the molten raw material is a raw material in a molten or semi-molten state,
characterized in that,
applying a current through the solid raw material and the printed workpiece, heating the solid raw material located between the guiding device and the printed workpiece into a molten state by way of resistance heating, and generating the molten raw material in a space located between the guiding device and the printed workpiece,
the form of the solid raw material is linear or rod-shaped, the molten raw material is at the front end of the solid raw material and adheres to the solid raw material,
the position of the molten raw material is controlled by the processes of: the molten raw material is pushed toward the printed workpiece or the support platform and is far away from the guiding device by the moving caused by the solid raw material's outputting from the guiding device, and the accumulating position of the molten raw material is controlled by the relative moving between the solid raw material and the printed workpiece,
wherein, in the process of accumulating the molten raw materials:
heating the area of the printed workpiece where the molten raw material is about to be accumulated and/or is being accumulated, which is independent of the resistance heating generated by applying current through the solid raw material and the printed workpiece;
the solid raw material is a conductive material.

2. The three-dimensional printing method according to claim 1, characterized in that,
the area of the printed workpiece where the molten raw material is about to be accumulated is heated to generate a molten pool, which is independent of the resistance heating generated by the current applied through the solid raw material and the printed workpiece.

3. The three-dimensional printing method according to claim 1, characterized in that,
the solid raw material located between the guiding device and the printed workpiece is partially heated into a molten state by way of resistance heating caused by the current applied through the solid raw material and the printed workpiece, and the molten raw material is generated in a space located between the guiding device and the printed workpiece.

4. The three-dimensional printing method according to claim 1, characterized in that,
the solid raw material located between the guiding device and the printed workpiece is completely heated into a molten state by way of resistance heating caused by the current applied through the solid raw material and the printed workpiece, and the molten raw material is produced in a space located between the guiding device and the printed workpiece.

5. The three-dimensional printing method according to claim 1, characterized in that,
the current is applied through the solid raw material and the printed workpiece, part or all of the solid raw material in contact with the printed workpiece is heated to a molten state or a semi-molten state by way of resistance heating, and the molten raw material is produced in the space between the solid raw material and the printed workpiece;
and/or, the current is applied through the solid raw material and the printed workpiece, part or all of the solid raw material adjacent to the printed workpiece is heated to a molten state or a semi-molten state by way of resistance heating, and the molten raw material is produced in the space between the solid raw material and the printed workpiece; the solid raw material adjacent to the printed workpiece refers to the solid raw material adjoining to the molten raw material being accumulated.

6. The three-dimensional printing method according to claim 1, characterized in that,
the printed workpiece is supported by a support platform, and the support platform is a device or structure for supporting the printed workpiece during the three-dimensional printing process.

7. (canceled)

8. The three-dimensional printing method according to claim 1, characterized in that,
the heating at the area of the printed workpiece where the molten raw material is about to be accumulated and/or is being accumulated is caused by a method which comprises one or a combination of at least two of plasma heating, electrical arc heating, electromagnetic induction heating, resistance heating, laser heating, electron beam heating, and microwave heating.

9. The three-dimensional printing method according to claim 1, characterized in that,
the main steps of the three-dimensional printing method include:
Step S1: heating the part of the printed workpiece where the molten raw material is about to be accumulated;
Step S2: outputting the solid raw material from the guiding device;
Step S3: establishing an electrical connection between the solid raw material and the printed workpiece, that is, the current can flow through the solid raw material and the printed workpiece, which is a resistance connection, not a connection via an electrical arc;
Step S4: applying current through the solid raw material and the printed workpiece, partially or completely heating the solid raw material between the guiding device and the printed workpiece into a molten state by way of resistance heating;
Step S5: controlling a scanning position of the solid raw material on the printed workpiece by regulating the relative position between the guiding device and the printed workpiece, at the same time outputting the solid raw material from the guiding device; during this process, heating the area of the printed workpiece where the molten raw material is about to be accumulated and/or heating the area of the printed workpiece where the molten raw material is being accumulated, applying current through the solid raw material and the printed workpiece and performing resistance heating on the solid raw material to continuously produce the molten raw material;
the guiding device contacting with the solid raw material and the printed workpiece, act as the electric interfaces for the current flowing through the solid raw material and the printed workpiece, or to apply current through an electrode which contacting with the solid raw material and the printed workpiece act as the electric interfaces.

10. The three-dimensional printing method according to claim 1, characterized in that,
when there is no need to continue producing the molten raw material, or when the three-dimensional printing is suspended or stopped, the current is applied through the solid raw material and the printed workpiece, with the current intensity that is sufficient to fuse and break the molten raw material between the guiding device and the printed workpiece, or sufficient to fuse and break the molten raw material between the electrode contacting with the solid raw material and the printed workpiece.
